(19) United States
(12) Patent Application Publication
(10) Pub. No.: US 2010/0026597 A1
(43) Pub. Date: Feb. 4, 2010

(54) Antenna

(75) Inventor: Koji Yano, Nishinomiya-City (JP)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Furuno Electric Company Limited, Nishinomiya-City (JP)

(21) Appl. No.: 11/880,015

(22) Filed: Jul. 19, 2007

(30) Foreign Application Priority Data
Jul. 24, 2006 (JP) 2006-200349

(51) Int. Cl. H01Q 13/00; H01Q 1/42

(52) U.S. Cl. 343/772; 343/872

(57) ABSTRACT

It is an object of the invention to provide an antenna with small side-lobe while narrowing the beam width to a desired one without the antenna increased in weight. Besides, it is also an object of the invention to decrease the manufacturing process less than ever before and reduce the cost. Furthermore, it is also an object of the invention to improve stability when the antenna is turned.

In order to solve the above-mentioned problems, the antenna of the invention is characterized by comprising a radiator which is configured to radiate electromagnetic wave inside of an antenna housing, at least one dielectric which is configured to be contributory to directivity angle of the electromagnetic wave in the vertical direction, and characterized in that the dielectric is attached to the antenna housing ahead of the radiator.

The antenna 30 is provided with slots 32 in front of the radiator 31. It is possible to narrow the beam width in the horizontal direction by way of the slots 32. Narrowing the beam width in the horizontal direction can improve the azimuth resolution of the antenna 30. The dielectrics 34a-c are provided through the transition portion 33 ahead of the radiator 31. The height of the transition portion 33 is practically equal to the height of the antenna housing 35a-b made up of the dielectric material, and the transition portion 33 electromagnetically-couples efficiently between the radiator 31 and the dielectrics 34a-c.

By providing the dielectrics 34a-c ahead of the radiator 31, it is possible to keep the beam from spreading in the vertical direction and to keep the beam narrow in width. That is to say, it is possible to determine desired beam width by changing permittivity and length of the dielectrics 34a-c.

The dielectrics 34a-c are provided with their longitudinal sides disposed in the direction of the radial axis showing the center of radiation. The dielectrics 34a-c and the antenna housing 35a-b are provided in the form of a layer nearly perpendicular to the radial axis and uniformly spaced in the order of upper surface 35a of the antenna housing, a dielectric 34a, a dielectric 34b, a dielectric 34c, and lower surface 35b of the antenna housing. Furthermore, the dielectrics 34a-c are supported by the support member 36 disposed in the antenna housing 35a-b. In this manner, since the dielectrics 34a-c and the antenna housing 35a-b are provided in the form of a layer, interference occurs (that is, interference among the layers of the dielectrics 34a-c) which is attributable to interference between the upper surface 35a of the antenna housing and the lower surface 35b of the antenna housing, which causes the side-lobe. It is possible to reduce the side-lobe of the beam radiated outside of the antenna housing 35a-b due to interaction of each individual interference.

In addition, although the support member 36 is made of the dielectric material similar to the dielectrics 34a-c, the support member does not contribute greatly to different permittivity, narrowing of the beam width, and reduction of the side-lobe. Therefore, the dielectrics and the support member shall be classified into different factors in view of object and effect.

The antenna 30, however, is heavier due to the presence of dielectrics 34a-c and the support member 36. In general, with regard to the antenna capable of radiating desired beams, its weight is enumerated as one of the important subjects to be improved. The antenna is rotated by a motor for 360° degrees of detection around the antenna. Therefore, as antenna weight increases, the power of the motor must be increased and the strength of a base supporting the antenna must also be increased.

For the antenna 30 described in Japanese Patent No. 3,634,372, the support member 36 is required to dispose and support the dielectrics 34a-c. In addition, it is necessary to form insertion slots for disposing the dielectrics 34a-c in the support member 36, which complicates the manufacturing process of the antenna 30.

The present invention is devised to address the above-mentioned problems. It is an object of the invention to provide an antenna with small side-lobe while narrowing the beam width to a desired width without increasing antenna weight. It is also an object of the invention to reduce the manufacturing requirements and the cost. Furthermore, it is also an object of the invention to improve stability during antenna rotation.

### SUMMARY OF THE INVENTION

In order to solve the above-mentioned problems, the invention, in one aspect, is directed to an antenna characterized by comprising a radiator which is configured to radiate electromagnetic waves inside of an antenna housing, at least one dielectric which is configured to be contributory to directivity angle of the electromagnetic wave in the vertical direction, and characterized in that the dielectric is attached to the antenna housing ahead of the radiator.

### BRIEF DESCRIPTION OF THE DRAWINGS

FIG. 1 is an end elevation showing one example of the configuration of the antenna in one embodiment according to the invention.

FIG. 2 is a view showing the result of simulation for the directivity characteristics of the antenna according to the embodiment of the invention shown in FIG. 1.

FIG. 3 is a view showing the result of simulation when dielectric and antenna housing are not considered.

FIG. 4 is an end elevation showing one example of the configuration of the antenna in another embodiment according to the invention.

FIG. 5 is an end elevation showing one example of the configuration of the antenna in the embodiment shown in FIG. 4.

FIG. 6 is an end elevation showing one example of the configuration of the antenna in the embodiment shown in FIG. 4.

FIG. 7 is an end elevation showing the configuration of the antenna according to related art.

### DETAILED DESCRIPTION

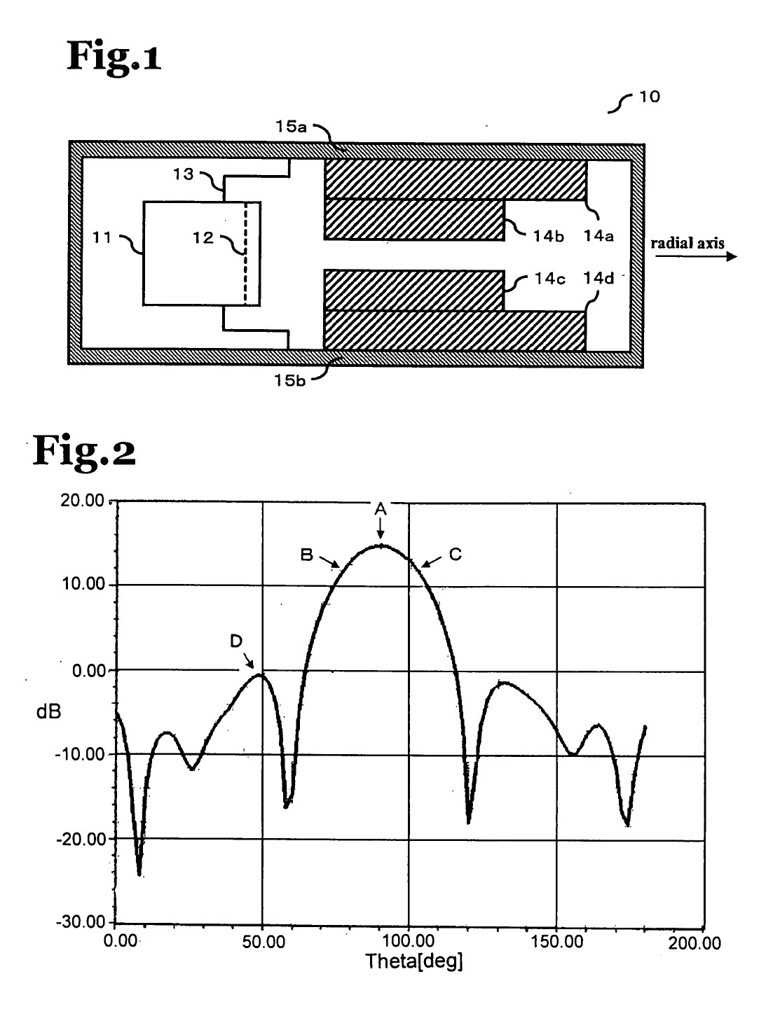

The antenna 10 in one embodiment of the invention is described below by referring to FIG. 1 showing an end elevation of one example of the configuration of the antenna.

The antenna 10 comprises a radiator 11, slots 12, a transition portion 13, a plurality of dielectrics 14a-d, and antenna housing 15a-b.

The antenna 10 is provided with slots 12 in front of the radiator 11. It is possible to narrow the beam width of the electromagnetic wave radiated from the radiator in the horizontal direction by way of the slots 12. Narrowing the beam width in the horizontal direction can improve the azimuth resolution of the antenna 10. The dielectrics 14a-d are provided through the transition portion 13 ahead of the radiator 11. The height of the transition portion 13 is practically equal to the height of the antenna housing 15a-b, and the transition portion 13 electromagnetically-couples efficiently between the radiator 11 and the dielectrics 14a-d.

The dielectrics 14a-d are provided with longitudinal sides in parallel to the direction of the radial axis. Since the beam width in the vertical direction depends on the permittivity and length of the dielectrics 14a-d, it is possible to obtain desired beam width by changing these factors. The length of the dielectrics 14b and 14c are shorter than that of the dielectrics 14a and 14d as described below, with the end positions of the dielectrics 14a-d on the radiator side aligned to each other. Therefore, since the weight is more concentrated on the inner side than on the outer side of the antenna 10, it is possible to impart more stability to the antenna 10 when rotated.

The dielectrics 14a-d and the antenna housing 15a-b are provided in the form of a layer nearly perpendicular to the radial axis in the order of upper surface 15a of the antenna housing, the dielectric 14a, the dielectric 14b, the dielectric 14c, the dielectric 14d, and the lower surface 15b of the antenna housing. In addition, the outermost dielectrics 14a and 14d are in close contact with the antenna housing 15a and 15b, respectively. Furthermore, one side of the dielectric 14b comes into contact with the dielectric 14a, and one side of the dielectric 14c comes into contact with the dielectric 14d. In this manner, at least one side of the dielectrics 14a and 14d comes in contact with the antenna housing 15a-b and other dielectrics 14b and 14c. Therefore, when the dielectrics 14a-d are provided inside of the antenna housing 15a-b, it is possible to reduce the number of components without requiring a separate support member and so forth. Furthermore, the weight of the antenna can be reduced.

The dielectrics 14a-d are provided symmetrically and perpendicularly to the radial axis. The permittivity and length of the dielectrics 14a and 14d and/or the dielectrics 14b and 14c are equally set, respectively. This allows the directivity characteristics of the beam to be symmetric with respect to the radial axis. However, since asymmetric configuration can also tilt and radiate the beam, it is not always necessary for the dielectrics 14a-d to be symmetric.

In another embodiment, a foam dielectric can be used for the dielectrics 14a-d. The use of a foam dielectric enables the permittivity to be simply adjusted depending on the degree of foaming. In addition, the lower the permittivity, the larger the foaming area increases. Accordingly, it is also possible to lighten its weight.

The permittivity and length of the dielectrics 14a-d can be determined using simulation so that a beam obtains the desired directivity characteristics. Each value of dielectrics 14a-d is described below in conjunction with the result of a simulation for the directivity characteristics of the antenna 10.

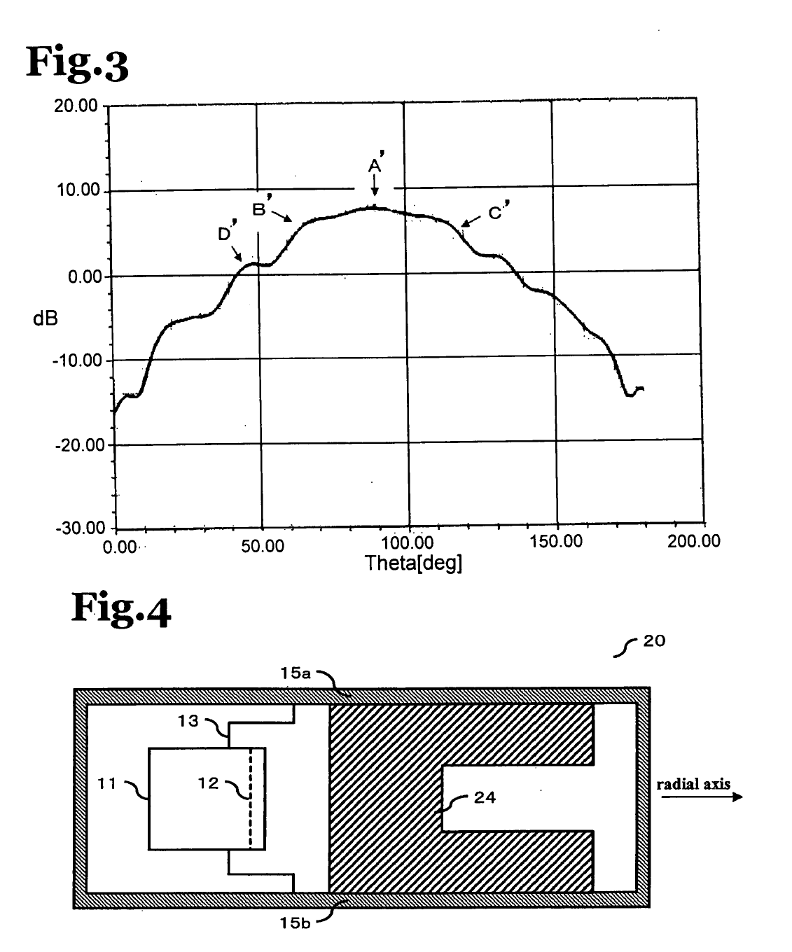

FIG. 2 shows the result of a simulation for the directivity characteristics of the antenna 10. The results of FIG. 2 can be compared to FIG. 3 showing the results of a simulation wherein dielectrics 14a-d and antenna housing 15a-b are not considered. In FIGS. 2 and 3, the axis of abscissas indicates an angle, and an axis of ordinate indicates a gain. The dielectrics 14a-d are disposed at a distance of 20 mm from the radiator 11. The dielectrics 14a and 14d are 1.5 in permittivity, 80 mm in length, and 7.0 mm in height. The dielectrics 14b and 14c are 1.3 in permittivity, 62 mm in length, and 7.0 mm in height. In addition, the antenna housing is 4.0 in permittivity, 32 mm in height, and 1.0 mm in thickness. These values are experimentally calculated so that adequate gain is obtained at 25° of directivity angle of a beam, provided that one wavelength is 32 mm. The antenna, however, is not restricted to these values. Directivity angle generally represents a range of angles in which a difference of gain from a point (with highest gain) in the direction of radial axis is within 3 dB.

With regard to the result of the simulation shown in FIG. 2, point A (θ=90°) indicates the direction of radial axis, and points B (θ=78°) and C (θ=103°) indicate a maximum directivity angle of a beam. In addition, point D (θ=30°) indicates a point where the side-lobe occurs significantly. It is found from FIG. 2 that a beam with desired directivity angle can be formed in a configuration like the antenna 10. Furthermore, it is also found in reference to the side-lobe that a gain can be reduced up to a difference of about 15 dB or more as compared with that at point A (θ=90°) in the direction of radial axis of a beam. Accordingly, it is found that suitable beams for detecting targets at sea can be obtained by providing the antenna 10 with dielectrics 14a-d configured at the above-mentioned values.

With regard to the result of a simulation as shown in FIG. 3, point A′ (θ=90°) indicates the direction of the radial axis of a beam, and points B′ (θ=65°) and C (θ=115°) indicate a maximum directivity angle of a beam. In addition, point D′ (θ=45°) indicates a point where the side-lobe occurs significantly. In FIG. 3, it is found that directivity angle of a beam is about 60° when the dielectrics 14a-d and the antenna housing 15a-b are not taken into account. That is to say, it is confirmed that the directivity angle of a beam is appropriately narrowed in the configuration of the antenna 10. A difference of gain between the point D′ (θ=45°) where the side-lobe occurs significantly and the point A (θ=90°) in the direction of radial axis of a beam is about 7 dB. Namely, it is confirmed that, in reference to the side-lobe, the gain can also be reduced greatly in comparison with the gain in the radial axis.

In the above-mentioned configuration, the antenna can radiate a beam with small side-lobe in a desired beam width. Since it is not necessary to support the dielectrics with a support member and so forth, the weight of the antenna can be reduced. Furthermore, since the weight is more concentrated on the inner side than on the outer side of the antenna, is possible to impart more stability to the antenna 10 when rotated. Furthermore, since a support member is not required to provide support to an insertion slot and the antenna, it is possible to reduce the manufacturing requirements and the cost.

It is also possible to increase antenna 10 stability by filling in the space between the dielectrics 14b and 14c. Although there is a clearance between the dielectrics 14b and 14c of the antenna 10, it is possible to obtain a desired beam by adjusting the permittivity and size of the dielectrics 14a-d without creating clearance.

In another embodiment, the antenna 20 is described below by referring to FIG. 4 showing an end elevation of one example of the configuration of the antenna 20.

The dielectric 24 of an antenna 20 is characterized as being a concave form.

This dielectric 24 is in close contact with both upper and lower portions of the antenna housing 15a-b disposed ahead of a radiator 11. Furthermore, the dielectric 24 can have a length extending in the direction of the radial axis which can become longer the further away it is from the radial axis.

Furthermore, a foam dielectric can be used for the dielectric 24 wherein the foaming rate of the dielectric becomes low from the radial axis to the antenna housing in the vertical direction. Since the permittivity of the foam dielectric depends on its foaming rate, it is possible to increase the permittivity by decreasing the foaming rate. That is to say, the permittivity of the dielectric 24 increases from the radial axis to the antenna housing in the vertical direction.

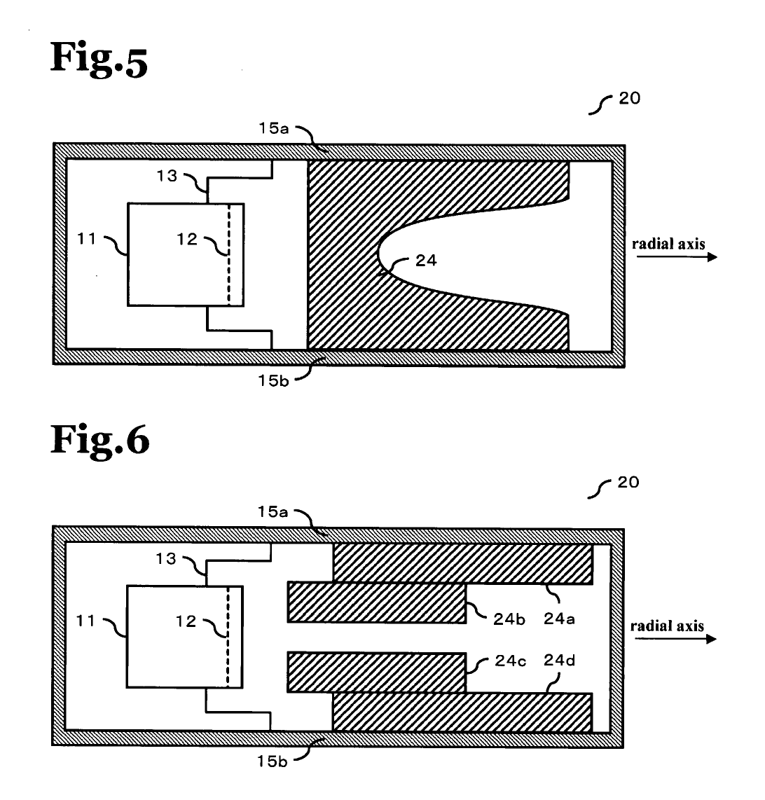

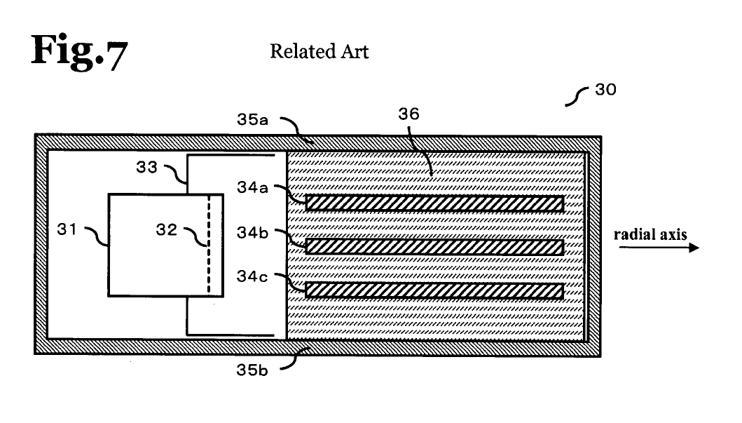

In another embodiment, the dielectric 24 can have its length changed radially as shown in FIG. 5. In another embodiment, the dielectrics 24 can be in the form of a layers as shown in FIG. 6. For example, the ends of the dielectrics 24a-d can be disposed at unequal distances from the radiator side of the radiator 11 to obtain desired properties of the antenna 20.

The invention is not restricted to the embodiments described above. For example, the invention is also applicable to a radome type antenna which rotates a radiator portion within a fixed antenna housing. Furthermore, the invention is not limited to use on ships to detect targets at sea, but may also be mounted on other vehicles such as aircraft and so forth for carrying out other types of detection.

According to the invention, it is possible to manufacture a light weight antenna capable of radiating the beams with desired beam width and small side-lobe. Furthermore, it is also possible to decrease the manufacturing process and reduce the cost. Furthermore, it is also possible to improve stability when the antenna is rotated.

We claim:

1. An antenna comprising:
a radiator which is configured to radiate electromagnetic wave inside of an antenna housing;
at least one dielectric which is configured to be contributory to directivity angle of the electromagnetic wave in the vertical direction;
wherein the dielectric is attached to the antenna housing ahead of the radiator.

2. The antenna as set forth in claim 1:
wherein the dielectric is attached to the upper and the lower portions of the antenna housing; and
the dielectric permittivity varies from the inside toward the outside of the antenna housing in the vertical direction.

3. The antenna as set forth in claim 2:
wherein the farther the dielectric is from the inside toward the outside of antenna housing in the vertical direction, the higher the dielectric permittivity is.

4. The antenna as set forth in claim 1:
wherein the farther the dielectric is from the inside toward the outside of antenna housing in the vertical direction, the longer the dielectric is.

5. The antenna as set forth in claim 1:
wherein the plurality of dielectrics are configured from layers in the vertical direction.

6. The antenna as set forth in claim 1:
wherein the dielectric permittivity is symmetric.

7. The antenna as set forth in claim 1:
wherein the dielectric is a foam dielectric.
